(19) United States
(12) Patent Application Publication
(10) Pub. No.: US 2013/0257658 A1
(43) Pub. Date: Oct. 3, 2013

(54) Method, apparatus, and computer-readable medium for detecting user presence

(71) Applicant: GUARDTRAX, LLC, Cranford, NJ (US)

(72) Inventor: Bernard Hall, Elizabeth, NJ (US)

(73) Assignee: GuardTrax, LLC, Cranford, NJ (US)

(21) Appl. No.: 13/851,666

(22) Filed: Mar. 27, 2013

Related U.S. Application Data
(60) Provisional application No. 61/685,922, filed on Mar. 27, 2012.

(51) Int. Cl. G01S 5/02

(52) U.S. Cl. CPC G01S 5/02
USPC 342/451

(57) ABSTRACT

An apparatus, computer-readable medium, and computer-implemented method for detecting user presence includes receiving an identifier code from a user device, the identifier code being associated with a transmitter, determining a location of the transmitter based at least in part on the identifier code, and determining that a user associated with the user device is near the location of the transmitter.

### RELATED APPLICATION DATA

This application claims priority to U.S. Provisional Application No. 61/685,922, filed Mar. 27, 2012, the disclosure of which is hereby incorporated by reference thereto in its entirety.

### BACKGROUND

Global Positioning Satellite (GPS) tracking has gained immense popularity in recent years, not only for vehicle tracking but also for personnel and package tracking One of the drawbacks of GPS tracking, however, is its inability to effectively track indoors. Indoor tracking is particularly important for personnel tracking.

Tracking devices typically incorporate not only a GPS receive engine, but also a cell modem utilizing mobile phone communications systems. Popular cell modem standards include GSM (Global System for Mobile communications) modems and CDMA (Code Division Multiple Access) modems. These cell modems can receive position data and other data from the GPS receive engine and transfer that data to a central server for locating and logging off relevant information. But in the absence of GPS reception (dependent on the ability to gain signals from GPS satellites), the cell modems cannot provide updated location information until GPS reception is restored. GPS signal reception is frequently attenuated or blocked by structures such that reception of GPS signals within buildings is precluded.

In many circumstances, it is desirable to track the location and position of a user who cannot be tracked using conventional GPS information due to signal attenuation or other inability of the device to receive GPS timing information. For example, Patrol Officers are required to perform guard tours on predefined routes on a regular basis. These routes can include both indoor and outdoor sections. It is necessary, for a variety of reasons, to have a record, both real and non-real time, of the location and route covered by the patrol officer. While outdoors the location information is easily recorded using GPS satellite tracking devices, these devices may be non-functional or perform poorly indoors.

In order to track indoor locations and positions, a variety of techniques have been utilized. For example, a manual paper trail can be used, where a user signs a sheet to indicate their presence at a particular location. Alternatively, card swiping, magnetic pick up wands, and location estimating Smartphone applications can also be utilized.

The existing methods suffer from the common drawback that the user (or subject of tracking) is required to be actively involved in the process. For instance, in the cases of cards and magnetic pick-up wands the user must physically swipe the card or press the wand to the magnetic pick-up tab that is physically located at the specific location. Not only is the officer required to perform a physical action, he or she is also required to have direct knowledge of the location of the card reader or magnetic tab.

There have been many other approaches to tracking devices. Some have used cellular or other radio frequency signal broadcasts to locate the position of a receiver unit by means of triangulation. The triangulation method relies on accurate measurement of the radial distance or direction of received signals from numerous cell towers. In an indoor setting, however, these signals are easily deflected, thus compromising the accuracy of the location estimation.

U.S. Pat. No. 6,697,630 to Corwith (“Corwith”) discloses an “automatic location identification system” for locating cell telephones dialing 911. The system compares the electronic footprint of a wireless 911 call with field strength data stored from the face of the cell tower in communication with the caller to ascertain the coordinates of a location polygon. But to perform location identification, Corwith must identify a number of cell towers and their location and measure the towers' signal strengths. Thus, similar to triangulation, the system's performance will be compromised in an indoor setting.

U.S. Pat. No. 7,411,549 to Krumm (“Krumm”) discloses an architecture for minimizing calibration effort in an IEEE 802.11 (Wi-Fi or WLAN) device location measurement system that uses a regression component to generate a regression function. Krumm, however, is an internal system. It cannot utilize the hardware and data typically available on current tracking devices, such as cell modems, but requires the use of new transmitters with new modems.

Similarly, U.S. Pat. No. 6,140,964 to Sugiura (“Sugiura”) discloses a method of detecting a position of a radio mobile station in radio communications that utilizes a neural network. But similar to Krumm, Sugiura is an internal system that cannot utilize the hardware and data typically available on current tracking devices.

U.S. Pat. No. 6,393,294 to Perez-Breva (“Perez-Breva”) discloses a method for determining the location of a mobile unit and presenting it to a remote party. But similar to Krumm and Sugiura, Perez-Breva cannot utilize the hardware and data typically available on current tracking devices. Perez-Breva requires its mobile units to have appropriate additional circuitry to capture the required signals. Additionally, the mobile units or an “Other Party” must also determine which portions of the spectrum to scan.

Others have performed indoor tracking by the placement of bar code strips that are manually read by a bar code reader, or by the placement of a wireless transmitter within a building and the use of carried readers. But like many of the approaches discussed above, these approaches require additional hardware or active user participation and have limited functionality.

Improved systems for tracking users and detecting user presence indoors are desired.

### BRIEF DESCRIPTION OF THE DRAWINGS

FIG. 1 illustrates a flowchart for detecting user presence according to an exemplary embodiment.

FIGS. 2A-2C illustrate enclosed and non-enclosed transmitters according to an exemplary embodiment.

FIGS. 3A-3B illustrate top-views of enclosed and non-enclosed transmitters according to an exemplary embodiment.

FIG. 4 illustrates flowcharts for the operation of the user device and transmitter with periodic transmission of the identifier code by the transmitter according to an exemplary embodiment.

FIG. 5 illustrates flowcharts for the operation of the user device and transmitter with a periodic request for an identifier code by the user device according to an exemplary embodiment.

FIG. 6 illustrates a flowchart for calculating the position of the user device with respect to a transmitter according to an exemplary embodiment.

FIG. 7 illustrates a flowchart for calculating the position of the user device according to an exemplary embodiment.

FIGS. 8A-8B illustrate the position of the user device relative to multiple transmitters and the transmitter signal strengths.

FIG. 9 illustrates an exemplary computing environment that can be used to carry out the method for detecting user presence according to an exemplary embodiment.

### DETAILED DESCRIPTION

While methods, apparatuses, and computer-readable media are described herein by way of examples and embodiments, those skilled in the art recognize that methods, apparatuses, and computer-readable media for detecting user presence are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

Applicants have discovered a way of detecting the presence and/or specific/relative location of a user (or subject) indoors using one or more transmitters, such as Radio Frequency Identification (RFID) signal transmitters, or active RFID tags. The system includes the placement of one or many transmitters that transmit a short range signal, which includes a unique identifier code, in the vicinity of, and in range of, a predefined location. Users in the vicinity of this location may carry a second device capable of receiving, storing, decoding and retransmitting the received data.

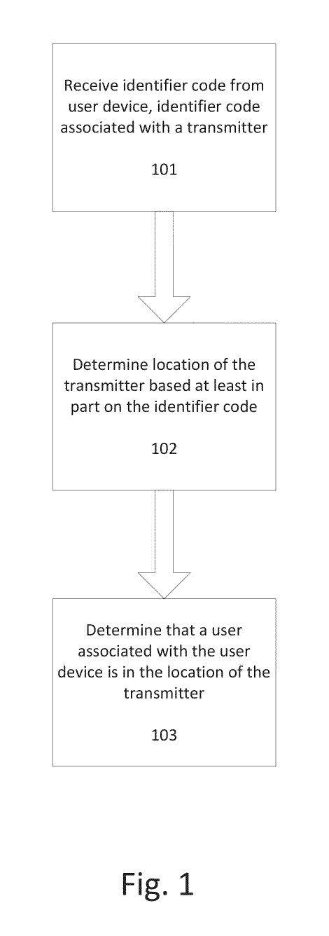

FIG. 1 is flowchart showing a method of detecting user presence according to an exemplary embodiment. At step 101, an identifier code is received from a user device, the identifier code being associated with a transmitter.

The user can be any user for whom indoor location tracking or presence detection is desired. For example, the user can be a police officer, security guard, a janitorial service employee, a maintenance crew member, a repair person, a maid, and/or any other type of user.

The user device can be carried by the user and registered to the user. User device can be a receiving device which is capable of receiving transmitted signals, such as radio frequency (RF) signals or infrared (IR) signals, and generating events and creating event strings that can include data received from the transmitter. The user device can receive the signals as described above and store the received information. The user device can also retransmit said information to a remote, central location, via some methodology including Wi-Fi, GPRS, internet protocols, etc. The user device can accept transmissions from the transmitter, can include a microcontroller to retrieve the information from the user device, can include a display to provide information to the user, can generate an event based upon reception of transmissions and can incorporate this information into an event string that contains the received information along with other relevant information such as time and user device ID, can store this information locally, and can retransmit this information by either wireless or wired means to a central server or other computing device.

The user device carried by the user can be capable of generating events and creating event strings that include such information as the time that the event was created, the reason for the event creation (e.g. elapsed preset time, change in device status such as going from being in constant motion to no motion, reception of a wireless transmission, detection of a key press). The user device can also be capable of detecting and recording the time when a transmitter comes into and goes out of range of the user device, as well as the total time that the transmitter was in range of the user device. The user device may be incorporated into a uniform worn by the user or as commonly worn by the class of users. Alternatively, the user device may be embedded into any object that the class of users is required to carry at all times for performing their specific function.

The transmitter can be a device that transmits a unique ID, such via RF or IR, over a short range (typically 1 foot to 100 feet), and can be implemented as an active or passive RF tag. The unique ID can be computed or determined by the transmitter or received at the transmitter. The transmissions from the transmitter can take place on a regular, preprogrammed and/or periodic basis, or can occur based upon an external stimulus, such as a request from another device, such as the user device. The range and direction of transmission can be set by varying the output power of the transmitting device or by enclosing the device in a “box” capable of partially absorbing the signal from the device. In the example of an RF transmitter, this box can be manufactured from metal, metal mesh or non-metallic materials coated with RF absorbing paints or other RF absorbing materials. In some instances, it may be desirable to configure a transmitter with a GPS device such that the absolute position of the transmitter may be determined. Position/directional information for a user device relative to a transmitter may be combined with the transmitter's GPS data as a relative offset to the transmitter's absolute position.

The transmitter can transmit a unique identifier code and other information such as device battery level or location specific information, via RF or IR, over a short range. The transmission can be encrypted and the transmitter can be capable of being fixed to a physical location. The transmitter can also be configured to allow for adjustments to the range of transmission.

Additionally, the transmitter can be configured to receive data, such as via RF or IR, store the data in internal electronic memory, and retransmit the data, upon request or automatically, to any device that comes in range of the transmitter.

For example, users can transmit messages to the transmitter for storage, such as a message or warning transmitted with the user device. These messages can be stored locally at the transmitter (in electronic memory or any other means known in the art) and then made available for transmission back to any device that comes in range of the transmitter.

As discussed earlier, the transmitter can be enclosed in such a way as to limit the directionality of the transmission of the transmitted signal. Using the example of an RF transmitter, the directionality can be limited by enclosing the transmitter into a box constructed from metal, metal mesh or non-metallic materials coated with RF absorbing paints or other RF absorbing materials. This box can then have regions of the RF absorbing materials removed to allow the RF signal to emerge from these “holes”. For instance, an all metal box can have a hole cut into it on one face so as to allow the RF signal to emerge from only one side. The size of this hole will depend upon the frequency of the RF transmission. Higher frequencies can require smaller holes and the hole size used can depend on the preferred frequency. Additionally, user devices can be configured to measure the reception power levels of the received signal to determine a particular region of interest.

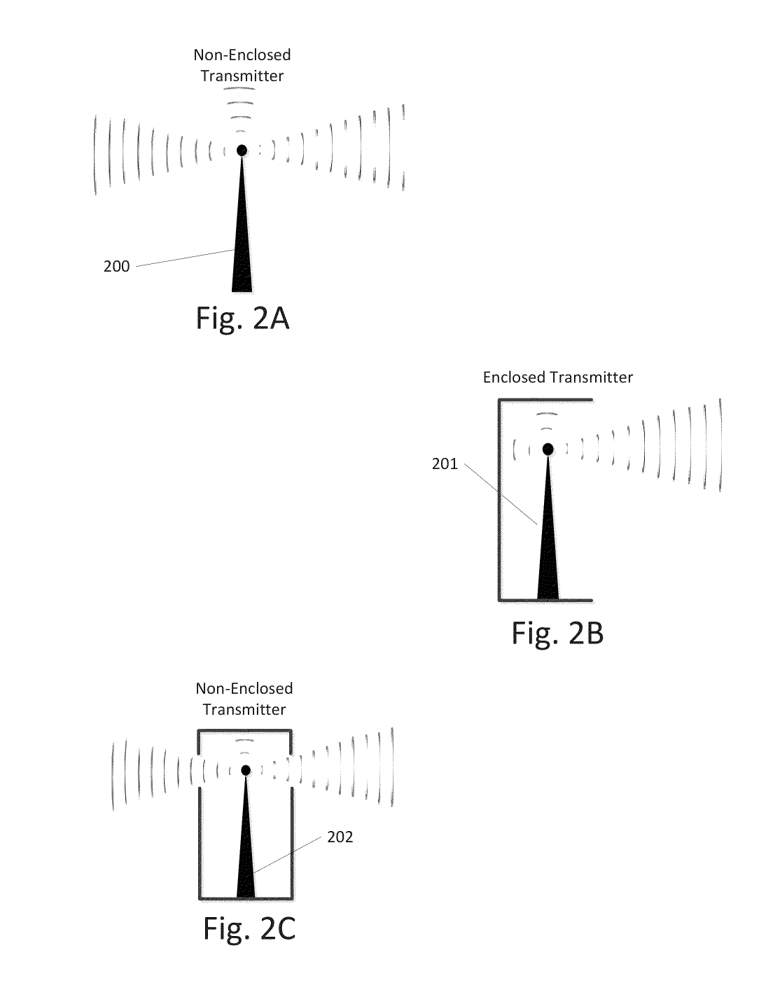

FIGS. 2A-2C show the effect of enclosing transmitters for the purpose of limiting the direction of the transmission. Transmitter 200 in FIG. 2A is not enclosed and transmits in all direction and transmitter 201 in FIG. 2B is bounded by a wall and transmits in one direction. Additionally, transmitter 202 in FIG. 2C is blocked from transmitting upwards but is not enclosed for the purposes of transmitting to the surrounding areas.

The transmission distance of the transmitter can be limited in all or specific directions for the purpose of creating a specific region through which the user would have to pass through in order to be detected by the device carried by that individual. For example, transmitters placed on walls or ceilings can be bounded so as not to initiate detection on the other side of said wall, or on the floor above the transmitter, detection of an individual walking down a corridor can be limited to a certain width, regardless of the length of the corridor. Received signal strength may be utilized to reject signals reflected from surfaces or structures, such that the attenuation of such signals from the secondary structure decreases the signal strength below a threshold, thus identifying a received signal as a reflection or other secondary signal reception. In some embodiments, intentional signal attenuation for a transmitter may be achieved by way of antenna design.

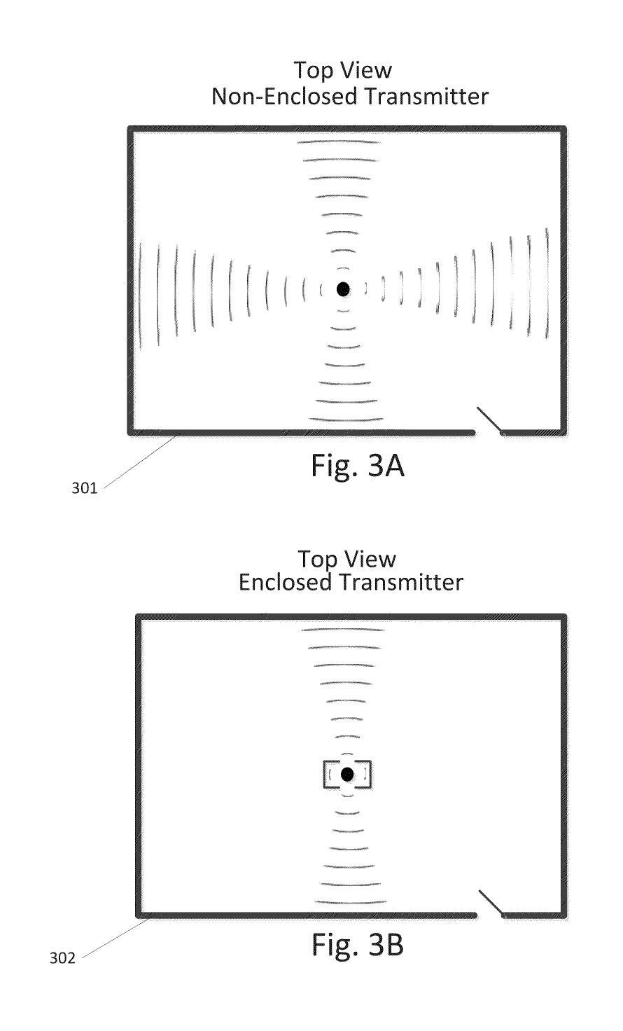

FIGS. 3A-3B illustrate the effect of enclosing the transmitter signal from a top view. FIG. 3A would be applicable if the information required was that the user device was located anywhere in the room 301, whereas the placement shown in FIG. 3B would be applicable for a situation where information is required relating to a user device moving through a defined region in room 302. For example, in a scenario where the user is a janitor and the purpose of detecting the user presence is to determine whether each bathroom stall has been cleaned. In addition, loitering criteria may be implemented to determine the length of time the janitor expended on each cleaning task corresponding to a defined space.

Limiting transmitters to specific directions can be important because RF transmission is often transparent to walls, ceilings and floors. For example, an RF tag (transmitter) placed in one room may equally transmit its signal into an adjacent room on the other side of the wall. Such a circumstance would lead to ambiguity as to the actual location of the user. In addition to the techniques used above to bound the direction of the signal, user location can be determined in part on the received signal strength (RSSI) of a signal received at the user device from the transmitter. In such a case it can be determined that lower signal levels are attributable to the passage of the signal through a wall.

The system can utilize one or more transmitters. Each transmitter can transmit a unique identifier code that is linked to a specific location and the transmitter can placed at that specific location. Transmitters can transmit over a short range and the range can be set so that the transmitters within a group do not have overlapping transmissions. As discussed earlier, the transmitters can be enclosed in such a way as to limit the directionality of the transmissions.

As a user device comes into and goes out of range of the specifically placed transmitters, an event is generated by the user device. An event in this context can be considered to have occurred by the fact that the device has received a signal from the transmitter or has lost contact with the transmitter. The event can include recognizing the change in status (gained or lost signal from transmitter), collecting peripheral information such as time, date and other information relating to the receiving device, into a transmission string, storing this data in local memory storage, transmitting this data to a server or other computing device for processing, analyzing the data for position and time information relating to movement between areas covered by different transmitters as well as time spent in vicinity of a single transmitter or group of transmitters.

Additionally, the event can include the unique identifier codes transmitted by the specifically placed transmitters and received at the user device. Returning to FIG. 1, as discussed previously, the identifier code that is associated with the transmitter is received from the user device at step 101. The data, including the identifier code, can be received at a server or other computing device connected to the internet and configured to receive data in any number of standard or even proprietary internet protocols. These protocols can include TCP and UDP and any other appropriate protocol known to those skilled in the field. Data flow to and from this server (or set of servers or other computing devices) can include hard wired internet connections, wireless internet connections as well as GPRS, 3G, 4G and related broadband wireless and telecomm transmission protocols.

At step 102 a location of the transmitter is determined based at least in part on the identifier code. This step can involve cross-referencing or otherwise looking up the relationship between the identifier code and the location information for a specific transmitter associated with that identifier code. For example, an identifier code may be looked up to determine which transmitter the identifier code is associated with. The transmitter information for this transmitter can then be looked up to determine the location of the transmitter.

This information can be kept in a database or other suitable data storage, on a central server or in a distributed fashion. Additionally, the user device can itself store this information so that the steps shown in FIG. 1 can all occur on the user device. In this situation, data can then later be transferred from the user device to another computing device.

At step 103, a determination is made that a user associated with the user device is near the location of the transmitter. This determination can be based at least in part on the fact that the identifier code associated with the transmitter was received from the user device associated with the user. Data or information may be transmitted or sent back to the user device, or to one or more other computing devices, based on this determination.

Additionally, the data received from the user device can be stored in a database or archive, compiled, analyzed, displayed, or transmitted to other computing devices. Software and algorithms capable of retrieving, analyzing and displaying reports based upon the received data or data stored in the database can also be utilized.

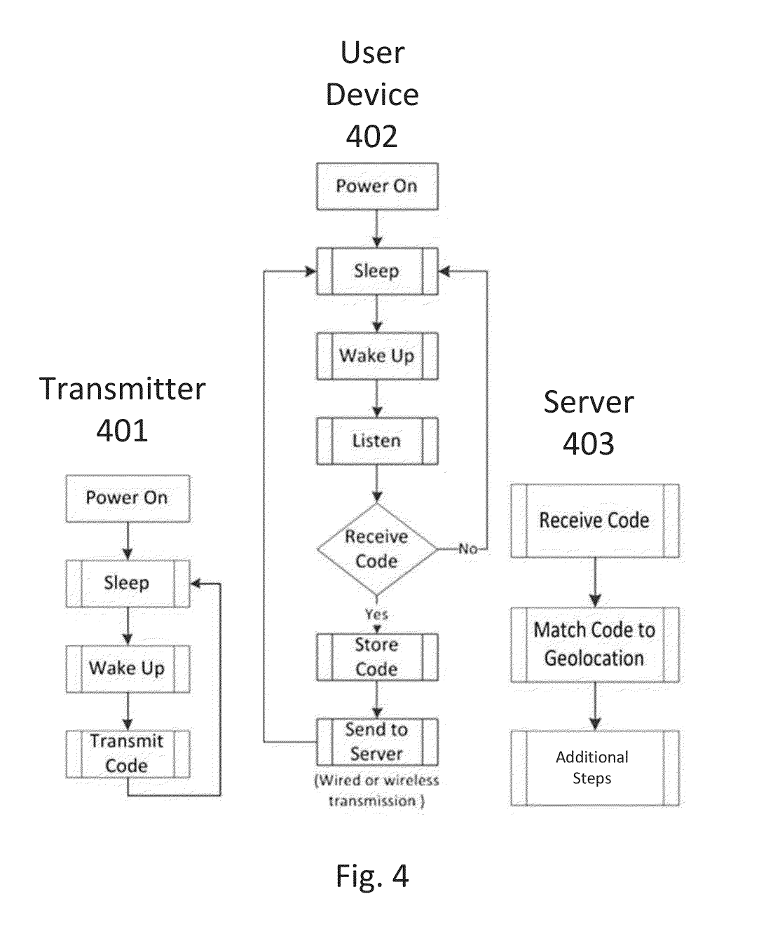

FIG. 4 illustrates flowcharts for a scenario where the transmitter periodically transmits information according to an exemplary embodiment. As shown in FIG. 4, the transmitter 401 wakes up, transmits, and goes back to sleep on a pre-programmed basis and the user device 402 wakes up, listens to determine whether an identifier code has been received, and goes back to sleep if no code has been received. In this scenario it is necessary for the user device to wake and listen at a frequency that is slightly faster than that of transmitter in order to ensure that the signal will be received. When a code is received by the user device from the transmitter, the code can be stored and sent to one or more other computing devices (indicated as server 403). The server 403 can receive the code, determine the location of the transmitter based on the code, and perform one or more additional steps as discussed earlier. These steps can include displaying data, calculating user position, updating databases, analyzing data, and any other steps related to the transmitter or user location information.

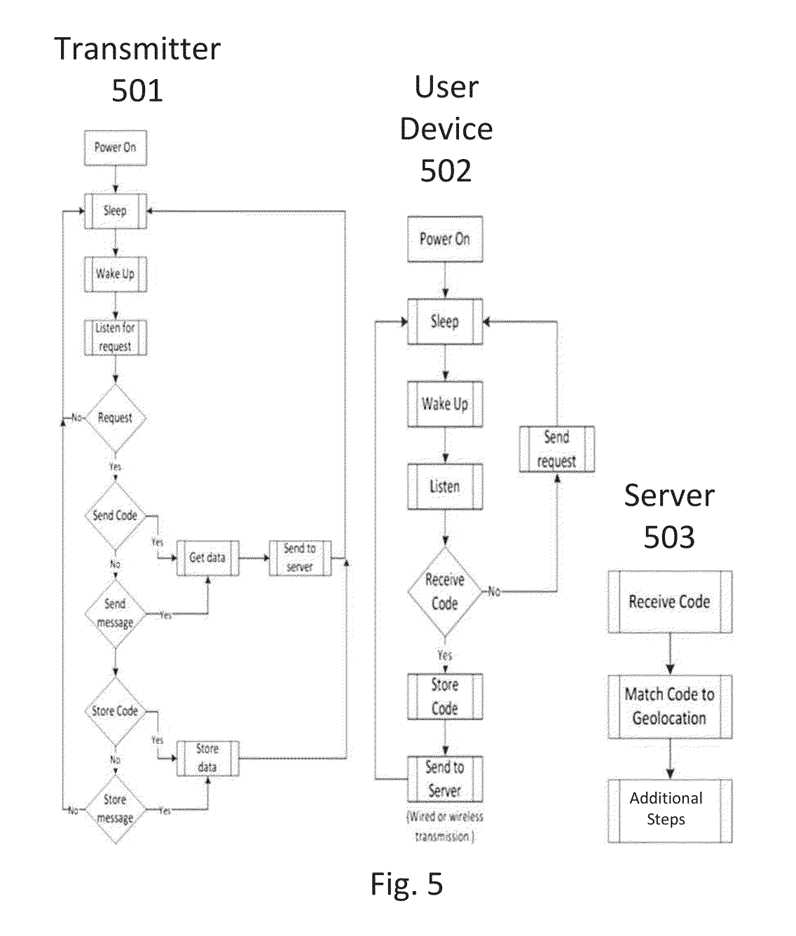

FIG. 5 illustrates flowcharts for a scenario where the user device requests the identifier code from the transmitter 501. The advantage is that the transmitter 501 is only required to wake up and listen on a periodic basis, rather than having to transmit information even when no user device 502 is in range. This methodology saves transmitter power. Additionally, the transmitter 501 can receive data and send the data to one or more other computing devices (indicated as server 503). The user device 502 can periodically send a request for an identifier code and determine if it has received the code. The transmitter can periodically check to see if a request has been received and send the code if a request has been received.

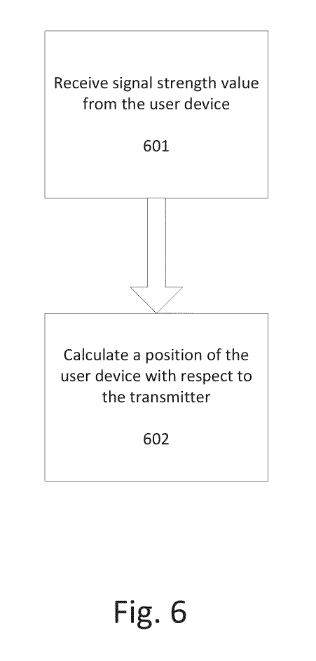

Referring to FIG. 6, a flowchart is shown for calculating the proximity of the user device to a transmitter according to an exemplary embodiment. A signal strength value can be received from the user device at step 601. The signal strength value can indicate the strength of the signal from the transmitter at the user device. At step 602 proximity of the user device to the transmitter can be calculated based at least in part on the signal strength value. This signal strength value can be a received signal strength (RSSI) as obtained by the user device and sent via the wireless and internet protocols already described above.

In some scenarios, multiple transmitters can be placed in proximity so as to allow for more granular determination of the location of the user device and the user. For instance, to determine whether the user in one half of a room or the other half, whether a user is in close proximity to a swimming pool gate that requires periodic checking, etc. It may be, conversely, required to know if a user is in the general vicinity. For instance, whether the user has left a facility. In this case a long range transmitter is required to cover that entire area. The overall distance of the transmitter can be adjusted, such as by adjusting the power of the antenna in the transmitter. The received power of the signal received at the user device can be used to determine if the user is in the desired range of the transmitter, rather than merely within range of the transmitter, for the purpose of specifically locating said individual.

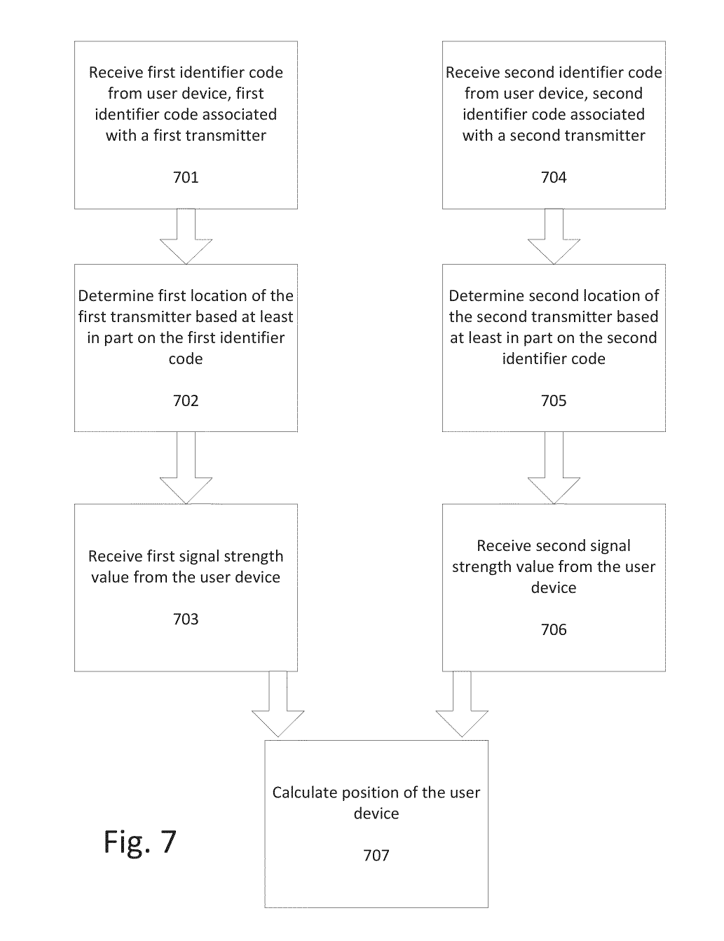

Referring to FIG. 7, a flowchart for calculating the position of the user device is shown according to an exemplary embodiment. At step 701 a first identifier code is received from a user device, the first identifier code associated with a first transmitter. At step 702 a first location of the first transmitter is determined based at least in part on the first identifier code. At step 703 a first signal strength value is received from the user device, the first signal strength value indicating the strength of the signal from the first transmitter at the user device. At step 704 a second identifier code is received from the user device, the second identifier code associated with a second transmitter. At step 705 a second location of the second transmitter is determined based at least in part on the second identifier code. At step 706 a second signal strength value is received from the user device, the second signal strength value indicating the strength of the signal from the second transmitter at the user device. At step 707 a position of the user device (and the user) is calculated based at least in part on the first location, the second location, the first signal strength value, and the second signal strength value.

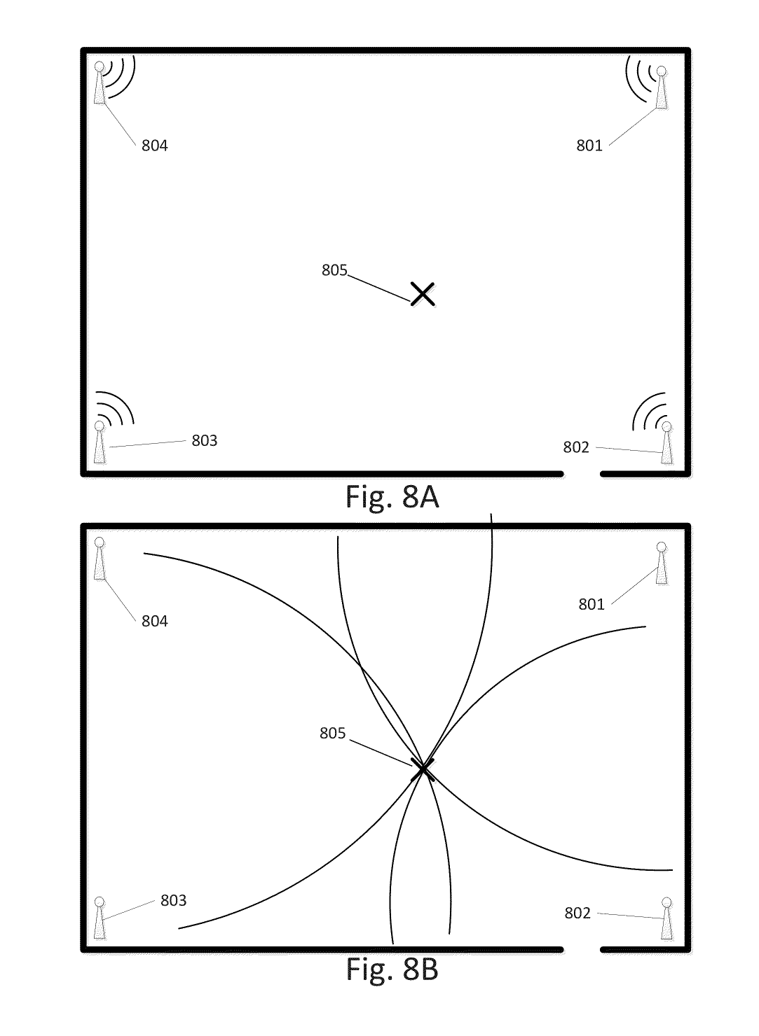

A group of transmitters can be arranged so that multiple signals can be received by the user device, allowing for finer determination of the location of a user. In this scenario the received signal strength (RSSI) as obtained by the user device and sent via the wireless and internet protocols already described above, can be analyzed to extract position information. For unobstructed transmission (meaning no obstacles in the path between transmitter and receiver), and assuming that the user lies within a boundary formed by the transmitters, as shown in FIG. 8A, the position of the user device 805 can be calculated using the RSSI values of the signals sent by the transmitters 801-804 as measured at the user device 805. This calculation requires not only knowledge of the RSSI from each transmitter but also the output power of the transmitter. These values, along with the understanding that RSSI varies as an inverse power of distance r between the transmitter and receiver, allows for position determination to within some accuracy which is very dependant upon environmental conditions. More explicitly, we can write: RSSI=K/rⁿ n=2,3,4 . . . , where K=a constant related to the output power of the transmitter.

For each received RSSI, a circular boundary can be traced, with the most likely position of the receiver being determined by the intersection region of the boundaries, as shown in FIG. 8B. Since the evaluation of K (and the translation between RSSI and distance) is a function of environmental conditions such as walls, obstacles, and reflections, the determination of K can be done experimentally. Some obstacles or unknowns can be difficult to account for, such as location of the user device with respect to the body of the user carrying it.

Since experimental determination of signal strengths as a function of position can be necessary for reasonably accurate positioning, an alternate method can be used, whereby the signal strengths of multiple transmitters are mapped as a function of known position, meaning at multiple points within a general location (say with in a room or within a building) the RSSI from each transmitter is recorded. This data forms inputs to a neural network pattern recognition program and thus forms a training set for the neural network. Once the neural network is trained, subsequent inputs, including the RSSI signals detected by the user device from the multitude of transmitters, can be rendered as a position.

The user device carried by the user can be capable of detecting and recording the time when the transmitter comes into and goes out of range of the user device, as well as the total time that the transmitter was in range of the user device. This start time and end time can be transmitted to a server or other computing system, where it can be received and used to calculate a duration, the duration indicating the length of time the user device was within the range of the transmitter. The end time can be determined based on when the user device loses the signal from the transmitter. Additionally, this calculation can be performed at the user device or measured directly at the user device. This duration measurement can be used to determine an amount of time that a particular user, such as an employee, loiters in an area.

The systems disclosed herein free users, such as patrol officers, from having to divert their attention from the specific task of patrol and observation in order to verify their location, and removes the burden of the user having to retain or enter specific location information relating to transmitters or user devices, as the location determination process can be accomplished without any active participation by the user.

As discussed earlier, the total time that the user is in range of the transmitter can be recorded for the purpose of verifying that the user spent a given amount of time in a given location. This feature is useful not only for security guards but for anyone who is working at a specified location where the time spent at said location is desired. For instance, a janitorial service employee who is sent to clean a restroom. The time spent by this person in the restroom can be recorded for verification that adequate time was spent at said location.

The systems and methods disclosed herein can be used for verifying the cleaning of restrooms by janitorial personnel, such as by utilizing active RFID. An RF transceiver and wireless communications device can be carried by the janitor and connected to a server and function as a user device, a short range RF transceiver can be located in the restroom and function as a transmitter. The system can also include an electronic display that updates its information relating to, for instance, the cleaning time and data of the restroom, based upon information gathered by the system and without direct input from the janitor. In addition, software algorithms running at the remote server, or another computing device, and utilizing data gathered by the RF transceiver, can allow for the information updates to the electronic display located in the restroom.

The RF transceiver/remote server system can detect the presence of the janitor in the restroom and measure the time that said janitor is in the restroom. In addition, using motion sensors on the device carried by the janitor, along with position information collected from a multitude of tags within said restroom, the time and activity of the janitor can be monitored. Based upon this electronically collected information a determination can be made that the restroom has been cleaned. Upon making such a determination, the remote server or other computing device, via wireless or wired communications, can update the information displayed on the electronic display in said restroom. Of course, all determinations and calculations can be made at a user device, instead of or in addition to, the remote server.

Of course, the system can be used for a variety of users and purposes, including janitors or cleaning services, lifeguards, security guards, police officers, or any other users that can be tracked. The system can include an electronic display capable of displaying time and date and other information gathered by user devices, transmitters, or calculated from gathered information. This display can be connected to a remote server, or any other suitable computing device, to allow for updating of the display information in connection with new data.

For example, in the case of janitorial workers, restroom owners and janitorial service company owners can be updated automatically as the restrooms are cleaned, and exception reports be generated and provided to supervisors or other parties when restrooms have not been cleaned per schedule.

Periodic cleaning of restrooms is desired and in many cases required by law. In order to assure both users and owners of these restrooms that this periodic cleaning has been performed, an electronic display at said restroom, along with an electronic report sent to the restroom owners as well as other interested parties, can be provided using the system disclosed herein. Direct input by janitor to the electronic display is not required. This means that the janitorial staff does not need to be trained in the use of the device. Additionally, the system provides verification for the amount of the time spent by the janitor inside the restroom while performing the cleaning duties.

The system disclosed herein can utilize an active transmitting device, such as an active RFID tag and a user device capable of receiving the transmissions, for the purpose of determining the time, the amount of time and the continuity of motion and movement within a restroom by janitorial staff tasked with cleaning said restroom. Upon automatic collection and analysis of the collected data a computer algorithm running on a local or remote server or other computing device can then determine if criteria have been met that indicate that said restroom has been cleaned. If so, an electronic display in said restroom can be updated to display the time, date and any other required information, relating to the last cleaning of the restroom. In addition information relating to the cleaning, or lack of, can be sent via electronic means to any number of predetermined recipients, such as via email or text message.

As discussed earlier, the user device may also include a motion sensor to determine if the user is in motion. This data can also be transmitted to the server. A software algorithm can determines the time spent in active motion inside the restroom and another algorithm can determine if adequate cleaning has been performed based on one or more criteria. Additionally, the electronic display can be updated accordingly.

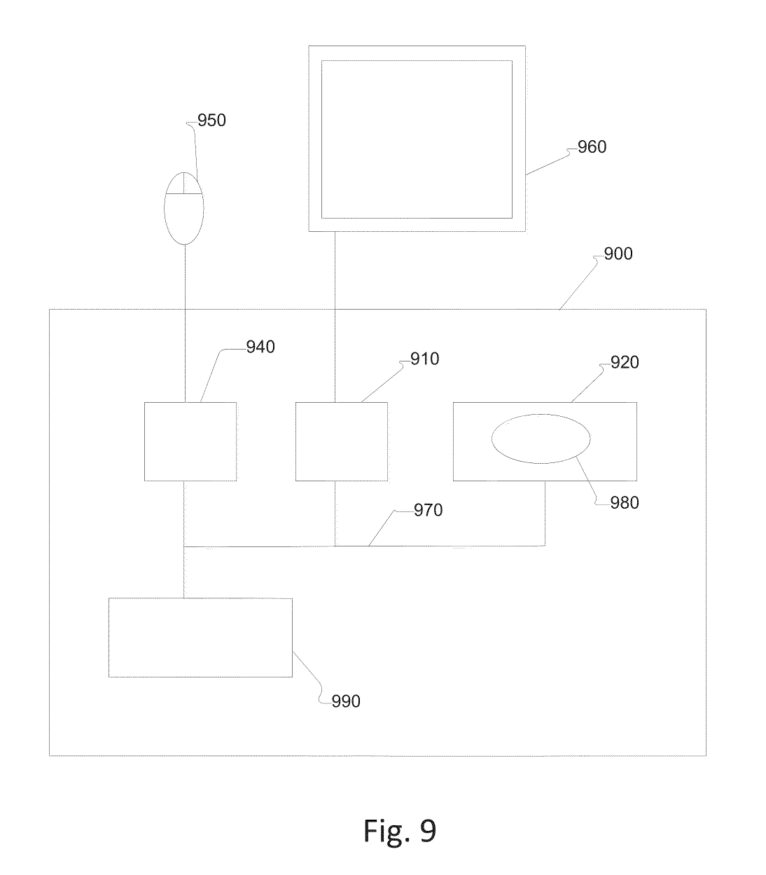

One or more of the above-described techniques can be implemented in or involve one or more computer systems. FIG. 9 illustrates a generalized example of a computing environment 1400. The computing environment 900 is not intended to suggest any limitation as to scope of use or functionality of a described embodiment.

With reference to FIG. 9, the computing environment 1400 includes at least one processing unit 910 and memory 920. The processing unit 910 executes computer-executable instructions and may be a real or a virtual processor. In a multi-processing system, multiple processing units execute computer-executable instructions to increase processing power. The memory 920 may be volatile memory (e.g., registers, cache, RAM), non-volatile memory (e.g., ROM, EEPROM, flash memory, etc.), or some combination of the two. The memory 920 may store software instructions 980 for implementing the described techniques when executed by one or more processors. Memory 920 can be one memory device or multiple memory devices.

A computing environment may have additional features. For example, the computing environment 900 includes storage 940, one or more input devices 950, one or more output devices 960, and one or more communication connections 990. An interconnection mechanism 970, such as a bus, controller, or network interconnects the components of the computing environment 900. Typically, operating system software or firmware (not shown) provides an operating environment for other software executing in the computing environment 900, and coordinates activities of the components of the computing environment 900.

The storage 940 may be removable or non-removable, and includes magnetic disks, magnetic tapes or cassettes, CD-ROMs, CD-RWs, DVDs, or any other medium which can be used to store information and which can be accessed within the computing environment 900. The storage 940 may store instructions for the software 980.

The input device(s) 950 may be a touch input device such as a keyboard, mouse, pen, trackball, touch screen, or game controller, a voice input device, a scanning device, a digital camera, remote control, or another device that provides input to the computing environment 900. The output device(s) 960 may be a display, television, monitor, printer, speaker, or another device that provides output from the computing environment 900.

The communication connection(s) 990 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 900, computer-readable media include memory 920, storage 940, communication media, and combinations of any of the above.

Of course, FIG. 9 illustrates computing environment 900, display device 960, and input device 950 as separate devices for ease of identification only. Computing environment 900, display device 960, and input device 950 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 900 may be a set-top box, mobile device, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method of detecting user presence by one or more computing devices, the method comprising:
receiving, by at least one of the one or more computing devices, an identifier code from a user device, wherein the identifier code is associated with a transmitter;
receiving, by at least one of the one or more computing devices, a signal strength value from the user device, wherein the signal strength value indicates the strength of the signal from the transmitter at the user device;
calculating, by at least one of the one or more computing devices, a position of the user device with respect to the transmitter based at least in part on the signal strength value.;
determining, by at least one of the one or more computing devices, a location of the transmitter based at least in part on the identifier code; and
determining, by at least one of the one or more computing devices, that a user associated with the user device is near the location of the transmitter.

2. The method of claim 1, wherein the identifier code is received by the user device from the transmitter based upon a request initiated by the user device.

3. The method of claim 1, wherein the identifier code is a first identifier code, the transmitter is a first transmitter, the location is a first location, the signal strength value is a first signal strength value, and further comprising:
receiving, by at least one of the one or more computing devices, a second identifier code from the user device, wherein the second identifier code is associated with a second transmitter;
determining, by at least one of the one or more computing devices, a second location of the second transmitter based at least in part on the second identifier code;
receiving, by at least one of the one or more computing devices, a second signal strength value from the user device, wherein the second signal strength value indicates the strength of the signal from the second transmitter at the user device; and
calculating, by at least one of the one or more computing devices, a position of the user device based at least in part on the first location, the second location, the first signal strength value, and the second signal strength value.

4. The method of claim 1, wherein the transmitter is a radio frequency identification tag.

5. The method of claim 1, further comprising:
receiving, by at least one of the one or more computing devices, a start time from the user device, wherein the start time is the time at which the user device entered into a range of the transmitter;
receiving, by at least one of the one or more computing devices, an end time from the user device, wherein the end time is the time at which the user device left the range of the transmitter; and
calculating, by at least one of the one or more computing devices, a duration based at least in part on the start time and the end time, wherein the duration indicates the length of time the user device was within the range of the transmitter.

6. The method of claim 4, wherein the radiation pattern of the transmitter is attenuated in at least one direction by the configuration of the transmitter enclosure.

7. The method of claim 4, wherein radiation pattern of the transmitter is attenuated in at least one direction by the design of the transmission antenna.

8. An apparatus for detecting user presence, the apparatus comprising:
one or more processors; and
one or more memories operatively coupled to at least one of the one or more processors and having instructions stored thereon that, when executed by at least one of the one or more processors, cause at least one of the one or more processors to:
receive an identifier code from a user device, wherein the identifier code is associated with a transmitter;
receive a signal strength value from the user device, wherein the signal strength value indicates the strength of the signal from the transmitter at the user device;
calculate a position of the user device with respect to the transmitter based at least in part on the signal strength value;
determine a location of the transmitter based at least in part on the identifier code; and
determine that a user associated with the user device is near the location of the transmitter.

9. The apparatus of claim 8, wherein the identifier code is received by the user device from the transmitter based upon a request initiated by the user device.

10. The apparatus of claim 8, wherein the identifier code is a first identifier code, the transmitter is a first transmitter, the location is a first location, the signal strength value is a first signal strength value, and wherein the one or more memories have further instructions stored thereon, that, when executed by at least one of the one or more processors, cause at least one of the one or more processors to:
receive a second identifier code from the user device, wherein the second identifier code is associated with a second transmitter;
determine a second location of the second transmitter based at least in part on the second identifier code;
receive a second signal strength value from the user device, wherein the second signal strength value indicates the strength of the signal from the second transmitter at the user device; and
calculate a position of the user device based at least in part on the first location, the second location, the first signal strength value, and the second signal strength value.

11. The apparatus of claim 8, wherein the one or more memories have further instructions stored thereon, that, when executed by at least one of the one or more processors, cause at least one of the one or more processors to:
receive a start time from the user device, wherein the start time is the time at which the user device entered into a range of the transmitter;
receive an end time from the user device, wherein the end time is the time at which the user device left the range of the transmitter; and
calculate a duration based at least in part on the start time and the end time, wherein the duration indicates the length of time the user device was within the range of the transmitter.

12. The apparatus of claim 8, wherein the transmitter is a radio frequency identification tag.

13. The apparatus of claim 12, wherein the radiation pattern of the transmitter is attenuated in at least one direction by the configuration of the transmitter enclosure.

14. The apparatus of claim 12, wherein radiation pattern of the transmitter is attenuated in at least one direction by the design of the transmission antenna.

15. At least one non-transitory computer-readable medium storing computer-readable instructions that, when executed by one or more computing devices, cause at least one of the one or more computing devices to:
receive an identifier code from a user device, wherein the identifier code is associated with a transmitter;
receive a signal strength value from the user device, wherein the signal strength value indicates the strength of the signal from the transmitter at the user device;
calculate a position of the user device with respect to the transmitter based at least in part on the signal strength value;
determine a location of the transmitter based at least in part on the identifier code; and
determine that a user associated with the user device is near the location of the transmitter.

16. The at least one non-transitory computer-readable medium of claim 15, wherein the identifier code is received by the user device from the transmitter based upon a request initiated by the user device.

17. The at least one non-transitory computer-readable medium of claim 15, wherein the identifier code is a first identifier code, the transmitter is a first transmitter, the location is a first location, the signal strength value is a first signal strength value, the at least one non-transitory computer-readable medium further comprising additional instructions that, when executed by one or more computing devices, cause at least one of the one or more computing devices to:
receive a second identifier code from the user device, wherein the second identifier code is associated with a second transmitter;
determine a second location of the second transmitter based at least in part on the second identifier code;
receive a second signal strength value from the user device, wherein the second signal strength value indicates the strength of the signal from the second transmitter at the user device; and
calculate a position of the user device based at least in part on the first location, the second location, the first signal strength value, and the second signal strength value.

18. The at least one non-transitory computer-readable medium of claim 15, the at least one non-transitory computer-readable medium further comprising additional instructions that, when executed by one or more computing devices, cause at least one of the one or more computing devices to:
receive a start time from the user device, wherein the start time is the time at which the user device entered into a range of the transmitter;
receive an end time from the user device, wherein the end time is the time at which the user device left the range of the transmitter; and
calculate a duration based at least in part on the start time and the end time, wherein the duration indicates the length of time the user device was within the range of the transmitter.

19. The at least one non-transitory computer-readable medium of claim 15, wherein the transmitter is a radio frequency identification tag.

20. The at least one non-transitory computer-readable medium of claim 19, wherein the radiation pattern of the transmitter is attenuated in at least one direction by the configuration of the transmitter enclosure.

21. The at least one non-transitory computer-readable medium of claim 19, wherein radiation pattern of the transmitter is attenuated in at least one direction by the design of the transmission antenna.
